(19) United States
(12) Patent Application Publication
(10) Pub. No.: US 2017/0080411 A1
(43) Pub. Date: Mar. 23, 2017

(54) CARBON DIOXIDE RECOVERY APPARATUS AND METHOD FOR TREATING EXHAUST GAS

(71) Applicant: Kabushiki Kaisha Toshiba, Minato-ku (JP)

(72) Inventors: Koshito FUJITA, Yokohama (JP); Naohiko Shimura, Atsugi (JP); Daigo Muraoka, Kawasaki (JP); Masatoshi Hodotsuka, Saitama (JP)

(21) Appl. No.: 15/367,343

(22) Filed: Dec. 2, 2016

Related U.S. Application Data
(63) Continuation of application No. PCT/JP2015/066000, filed on Jun. 3, 2015.

(30) Foreign Application Priority Data
Jun. 4, 2014 (JP) 2014-115817

(51) Int. Cl. B01J 35/00; B01J 29/06; B01D 53/78; B01D 53/86; B01D 53/62; B01D 53/75

(52) U.S. Cl. CPC B01J 35/004; B01D 53/62; B01D 53/75; B01D 53/78; B01D 53/8621; B01J 29/06; B01D 2252/204; B01D 2252/103; B01D 2252/504; B01D 2258/0283; B01D 2255/9202; B01D 2255/9207; B01D 2255/804

(57) ABSTRACT

A CO₂ recovery apparatus according to the present invention comprises: an absorption tower comprising a CO₂ absorption unit in which an exhaust gas containing CO₂ and a lean solution comprising an amino group-containing compound are brought into contact with each other to allow the lean solution to absorb CO₂; a regeneration tower in which CO₂ contained in a rich solution is separated to regenerate the rich solution; and a purification unit in which an amino group-containing compound in a CO₂-removed exhaust gas obtained by removing CO₂ in the CO₂ absorption unit is removed from, wherein the purification unit comprises a catalytic unit in which a photocatalyst is supported on a carrier including a gap through which air can pass, an activation member which activates the photocatalyst, and a power supply unit. The activation member is a pair of electrodes comprising a first electrode and a second electrode.

### CROSS-REFERENCE TO RELATED APPLICATIONS

This application is based upon and claims the benefit of priority from Japanese Patent Application No. 2014-115817, filed Jun. 4, 2014; the entire contents of which are incorporated herein by reference.

### FIELD

An embodiment of the present invention relates to a carbon dioxide recovery apparatus and a method for treating an exhaust gas.

### BACKGROUND

Carbon dioxide (CO₂) contained in combustion exhaust gases generated by combustion of fossil fuels in thermal power plants and the like is a greenhouse gas. Therefore, it has been pointed out that carbon dioxide is one of the causes of global warming. From the viewpoint of suppressing the global warming, it is necessary to reduce the amount of CO₂ emissions released by the combustion exhaust gases. As effective measures against the global warming problem, there has been pursued, for example, development of a CO₂ capture and storage (CCS: Carbon dioxide Capture and Storage) technology for separating and recovering CO₂ in combustion exhaust gases discharged from thermal power plants and the like, and for storing recovered CO₂ in the ground without emitting recovered CO₂ into atmosphere.

Specifically, there has been known a CO₂ recovery apparatus including an absorption tower in which an exhaust gas and an absorbing liquid containing an amino group-containing compound are brought into contact with each other to allow the absorbing liquid to absorb CO₂ in the exhaust gas and a regeneration tower in which the absorbing liquid allowed to absorb CO₂ is heated to release CO₂ from the absorbing liquid. In the absorption tower, CO₂ in the exhaust gas is absorbed in the absorbing liquid to remove CO₂ from the exhaust gas. The absorbing liquid allowed to absorb CO₂ (rich solution) is supplied into the regeneration tower, CO₂ is released from the absorbing liquid in the regeneration tower, the absorbing liquid is regenerated, and CO₂ is recovered. The absorbing liquid regenerated in the regeneration tower (lean solution) is supplied to the absorption tower and reused for absorbing CO₂ in the exhaust gas. In such a manner, in the CO₂ recovery apparatus, the absorbing liquid repeats the absorption of CO₂ in the absorption tower and the release of CO₂ in the regeneration tower, whereby CO₂ contained in the exhaust gas is separated and recovered.

In such an apparatus, the amino group-containing compound in the absorbing liquid is partly accompanied by a CO₂-removed exhaust gas obtained by removing CO₂ in the absorption tower. Therefore, in order to prevent occurrence of air pollution caused by the amino group-containing compound, it is necessary to inhibit the amino group-containing compound from scattering into atmosphere. Thus, as a method for removing the amino group-containing compound contained in the CO₂-removed exhaust gas, for example, a method for bringing a CO₂-removed exhaust gas into gas-liquid contact with water or an acid solution as a cleaning liquid, a method for allowing a packed bed filled with a catalyst, active carbon, or the like to adsorb an amino group-containing compound contained in an exhaust gas, or the like is used.

The amount of released exhaust gases discharged from thermal power plants or the like is a large quantity. Thus, it is necessary to suppress an increase in the amount of released amino group-containing compound accompanied by CO₂-removed exhaust gases. Therefore, in order to further utilize CO₂ recovery apparatuses in future, it is necessary to reduce ever further an amino group-containing compound accompanying by a CO₂-removed exhaust gas in an absorption tower and then released into atmosphere.

### BRIEF DESCRIPTION OF THE DRAWINGS

FIG. 1 is a schematic view illustrating the construction of a CO₂ recovery apparatus according to a first embodiment.

FIG. 2 is a view illustrating an example of the construction of a purification unit.

FIG. 3 is a view illustrating an example of the construction of the purification unit.

FIG. 4 is a view illustrating the other construction of the purification unit.

FIG. 5 is a view illustrating the other construction of the purification unit.

FIG. 6 is a view illustrating an example of the other construction of the CO₂ recovery apparatus.

FIG. 7 is a schematic view illustrating the construction of a CO₂ recovery apparatus according to a second embodiment.

FIG. 8 is a schematic view illustrating the construction of a CO₂ recovery apparatus according to a third embodiment.

FIG. 9 is a schematic view illustrating the construction of a CO₂ recovery apparatus according to a fourth embodiment.

FIG. 10 is a schematic view illustrating the construction of a CO₂ recovery apparatus according to a fifth embodiment.

FIG. 11 is a schematic view illustrating the construction of a CO₂ recovery apparatus according to a sixth embodiment.

FIG. 12 is a schematic view illustrating the construction of a CO₂ recovery apparatus according to a seventh embodiment.

FIG. 13 is a view illustrating an example of the other construction of the CO₂ recovery apparatus.

FIG. 14 is a schematic view illustrating the construction of a CO₂ recovery apparatus according to an eighth embodiment.

### DETAILED DESCRIPTION

A carbon dioxide recovery apparatus according to one embodiment comprises: an absorption tower comprising a CO₂ absorption unit in which an exhaust gas containing CO₂ and an absorbing liquid comprising an amino group-containing compound are brought into gas-liquid contact with each other to allow the absorbing liquid to absorb the CO₂; a regeneration tower in which the CO₂ contained in the absorbing liquid which absorbed the CO₂ is separated to regenerate the absorbing liquid; and a purification unit in which an amino group-containing compound in a CO₂-removed exhaust gas obtained by removing the CO₂ in the CO₂ absorption unit is removed from, wherein the purification unit comprises: a catalytic unit in which a photocatalyst is supported on a carrier comprising a gap through which air can pass; and an activation member which activates the photocatalyst.

A method for treating an exhaust gas according to another embodiment comprises: a CO₂ recovery step of bringing an exhaust gas containing CO₂ and an absorbing liquid comprising an amino group-containing compound into gas-liquid contact with each other in a CO₂ absorption unit in an absorption tower to allow the absorbing liquid to absorb the CO₂; and a purification step of activating a catalytic unit in which a photocatalyst is supported on a carrier comprising a gap through which air can pass while supplying a CO₂-removed exhaust gas obtained by removing the CO₂ in the CO₂ absorption unit to the catalytic unit, to decompose and remove an amino group-containing compound contained in the CO₂-removed exhaust gas.

Embodiments of the present invention will be described in detail below.

### First Embodiment

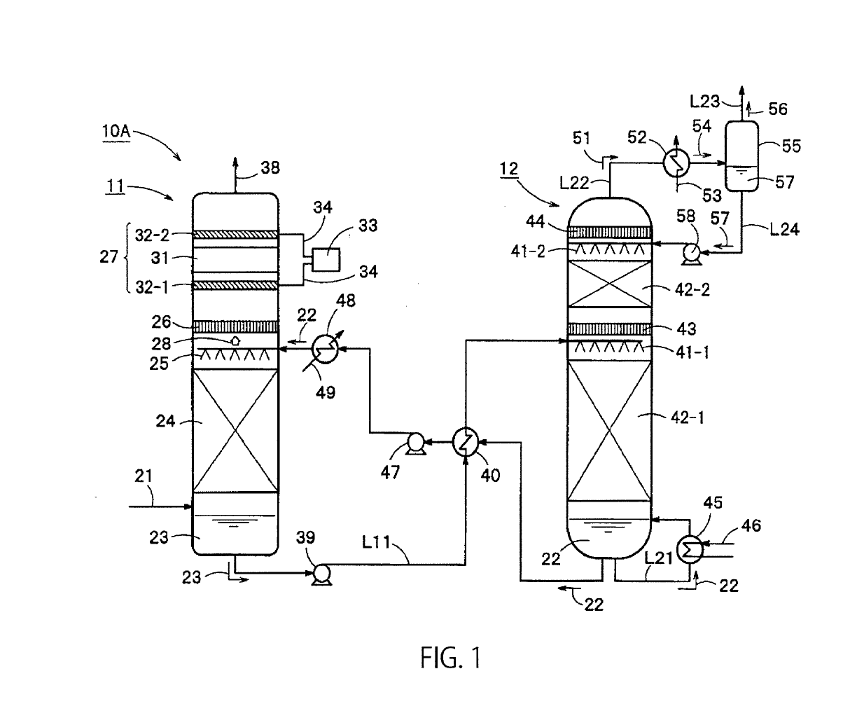

A carbon dioxide (CO₂) recovery apparatus according to a first embodiment will be described with reference to the drawings. FIG. 1 is a schematic view illustrating the construction of the CO₂ recovery apparatus according to the first embodiment. As illustrated in FIG. 1, the CO₂ recovery apparatus 10A comprises an absorption tower 11 and a regeneration tower 12.

In the CO₂ recovery apparatus 10A, an absorbing liquid 22 absorbing CO₂ in an exhaust gas 21 containing CO₂ circulates between the absorption tower 11 and the regeneration tower 12 (hereinafter referred to as “interior of system”). An absorbing liquid (rich solution) 23 allowed to absorb CO₂ in the exhaust gas 21 is fed from the absorption tower 11 to the regeneration tower 12. The absorbing liquid (lean solution) 22 regenerated by removing virtually all of CO₂ from the rich solution 23 in the regeneration tower 12 is fed from the regeneration tower 12 to the absorption tower 11. In the present embodiment, when an absorbing liquid is simply described, the absorbing liquid refers to the lean solution 22 and/or the rich solution 23.

The exhaust gas 21 is an exhaust gas containing CO₂, such as, for example, a combustion exhaust gas discharged from a boiler, a gas turbine, or the like in a thermal power plant or the like or a process exhaust gas generated from ironworks. The exhaust gas 21 is pressurized by an exhaust gas blower or the like, cooled in a cooling tower, and then supplied from a side wall of the tower bottom (lower portion) of the absorption tower 11 into the tower through a flue.

The absorption tower 11 brings the exhaust gas 21 containing CO₂ and the lean solution 22 into gas-liquid contact with each other to allow the lean solution 22 to absorb CO₂. The absorption tower 11 comprises: a CO₂ absorption unit 24 including a packing material for enhancing the efficiency of the gas-liquid contact; a liquid disperser 25; a demister 26; and a purifier 27, in the tower. The exhaust gas 21 fed into the tower flows from a lower portion in the tower toward a tower top (upper portion). The lean solution 22 is fed from the upper portion of the tower into the tower and dropped in the tower by the liquid disperser 25. In the absorption tower 11, the exhaust gas 21 moving upward in the tower comes into counterflow contact with the lean solution 22, and CO₂ in the exhaust gas 21 is absorbed in the lean solution 22 and removed, in the CO₂ absorption unit 24. The lean solution 22 absorbs CO₂ in the exhaust gas 21 in the CO₂ absorption unit 24 and becomes the rich solution 23, which is stored in a lower portion. A CO₂-removed exhaust gas 28 obtained by removing CO₂ in the CO₂ absorption unit 24 moves upward in the absorption tower 11.

A method of bringing the exhaust gas 21 into contact with the lean solution 22 in the absorption tower 11 is not limited to the method of dropping the lean solution 22 in the exhaust gas 21 to bring the exhaust gas 21 and the lean solution 22 into countercurrent contact with each other in the CO₂ absorption unit 24, but may be, for example, a method of allowing the lean solution 22 to bubble with the exhaust gas 21 to allow the lean solution 22 to absorb CO₂; and the like.

The absorbing liquid is an aqueous amine-based solution containing an amine-based compound (amino group-containing compound) and water. Examples of the amino group-containing compound contained in the absorbing liquid include primary amines containing one alcoholic hydroxyl group, such as monoethanolamine and 2-amino-2-methyl-1-propanol; secondary amines containing two alcoholic hydroxyl groups, such as diethanolamine and 2-methylaminoethanol; tertiary amines containing three alcoholic hydroxyl groups, such as triethanolamine and N-methyldiethanolamine; polyethylene polyamines such as ethylenediamine, triethylenediamine, triethylenetetramine, aminoethylethanolamine, and diethylenetriamine; cyclic amines such as piperazines, piperidines, and pyrrolidines; polyamines such as xylylenediamine; amino acids such as methylaminocarboxylic acid; and mixtures thereof. One of the amino group-containing compounds may be used singly, or two or more thereof may be used. The absorbing liquid preferably contains 10 to 70 mass % of the amino group-containing compound described above.

The absorbing liquid may appropriately contain, in addition to the amino group-containing compound and solvent such as water described above, arbitrary proportions of other compounds such as a reaction accelerator, a nitrogen-containing compound for improving the performance of absorption of an acid gas such as CO₂, an anticorrosive agent for preventing the corrosion of plant facilities, an antifoaming agent for preventing foaming, an oxidation inhibitor for preventing the deterioration of the absorbing liquid, and a pH adjuster as long as the effects of the absorbing liquid are not deteriorated.

Moisture in the CO₂-removed exhaust gas 28 is removed in the demister 26, followed by supplying the gas to the purifier 27.

The purifier 27 removes the amino group-containing compound in the CO₂-removed exhaust gas 28. The purifier 27 is disposed in the absorption tower 11. The purifier 27 is disposed in the upper side of the absorption tower 11, which is provided on a downstream side of the purification unit 27 in the gas flow direction of the CO₂-removed exhaust gas 28. The purifier 27 comprises a catalytic unit 31 and an activation member that activates a photocatalyst. In the present embodiment, the activation member is a pair of electrodes including a first electrode 32-1 and a second electrode 32-2 that is disposed to be opposed to the first electrode 32-1. Either the first electrode 32-1 or the second electrode 32-2 is an anode, and the other is a cathode. The pair of the first electrode 32-1 and the second electrode 32-2 is arranged to be opposed in such a way as to pinch the catalytic unit 31 in the gas flow direction of the CO₂-removed exhaust gas 28 in the absorption tower 11. The first electrode 32-1 and the second electrode 32-2 may be arranged on the inner wall of the absorption tower 11 in such a way as to pinch the catalytic unit 31, and are not particularly limited as long as the first electrode 32-1 and the second electrode 32-2 can be arranged to be opposed to each other.

The catalytic unit 31 is a photocatalyst carrier comprising: a carrier including a gap through which air can pass; and a photocatalyst that is supported on a surface of the carrier and is activated by, for example, irradiation with ultraviolet (UV) light.

Since the carrier comprises the gap through which air can pass, the CO₂-removed exhaust gas 28 can pass through the gap of the carrier. The carrier is formed of, for example, a fiber aggregate, a porous body, or the like. Examples of the fiber aggregate include compression-molded bodies of fibers, fabrics, non-woven fabrics, and the like. Examples of the porous body include a structure having a honeycomb shape. Of these, the fiber aggregate has a formed three-dimensional mesh structure so that the contact area of the fiber aggregate with a photocatalytic unit is increased while the fiber aggregate enables the CO₂-removed exhaust gas 28 to pass into the carrier. Therefore, it is preferable that the carrier is formed of the fiber aggregate.

An oxide such as alumina, silicon carbide, silicon nitride, ceria, zirconia, or silicon oxide, a composite oxide thereof, a silicate, aluminosilicate glass, or the like can be used as a material forming the carrier. For example, cordierite (Mg₂Al₄Si₅O₁₈) or the like can be used as the silicate. Particularly, when the carrier is a carrier having a three-dimensional mesh structure, such as a fiber aggregate, it is preferable to use a silicate containing cordierite as a principal component, as the material forming the carrier. A case in which the material forming the carrier is cordierite is preferred since it is difficult to peel the photocatalyst formed on the surface of the carrier from the carrier. The containing of cordierite as the principal component means that 50% by weight or more of the silicate is cordierite.

Such a material as described above is an insulating substance. Therefore, when a high voltage is applied between the first electrode 32-1 and the second electrode 32-2 to generate discharge light as described later, sliding creeping discharge is generated along a surface of the carrier. As a result, a discharge light is also generated from the carrier of the catalytic unit 31 allowing to irradiate the discharge light over the whole photocatalyst supported on the carrier.

The porosity of the carrier is preferably 60 to 90%, and more preferably 70 to 80%. The porosity of the carrier being within the range described above can increase the surface area of the carrier while reducing the pressure loss of the CO₂-removed exhaust gas 28. In addition, the strength of the carrier can be kept. Further, when the carrier is porous, it is easy to hold the amino group-containing compound in the pores of the carrier, and therefore, the adsorptivity of the amino group-containing compound in the carrier can be enhanced. Therefore, the porosity of the carrier being within the range described above can enhance the adsorptivity of the amino group-containing compound in the CO₂-removed exhaust gas 28 to the photocatalyst and can maintain the durability of the carrier while maintaining a state in which the CO₂-removed exhaust gas 28 easily pass through the carrier. Particularly, as described in the present embodiment, for efficiently treating a large amount of the high-temperature exhaust gas 21 discharged from, for example, the interior of a thermal power plant or the like it is important to reduce the pressure loss of the CO₂-removed exhaust gas 28 to keep gas permeability, to enhance the adsorptivity of the amino group-containing compound in the CO₂-removed exhaust gas 28, and to impart sufficient strength to the carrier so that the carrier is not damaged. The open porosity refers to the ratio of open pores to a volume and is a value obtained by dividing the sum of the volumes of all the open pores by the overall volume of the carrier. The open porosity can be determined based on ES R 1634 1998.

It is preferable that the carrier is formed of a porous substance. In a case in which the carrier is porous, when a high voltage is applied between the first electrode 32-1 and the second electrode 32-2 to generate discharge light as described later, a discharge light is also generated in the pores of the carrier. Therefore, irradiation with discharge light can be performed from the exterior and interior of the catalytic unit 31.

The photocatalyst is supported on the surface of the carrier, e.g., fixed on the surface of the carrier. Examples of a material forming the photocatalyst include titanium oxide (TiO₂), zinc oxide (ZnO), yttrium oxide, tin oxide, and tungsten oxide, as well as platinum, palladium, and rhodium. Of these, titanium oxide is preferably used as the material forming the photocatalyst because titanium oxide has high photocatalyst activity for discharge light having wavelengths of 300 nm to 400 nm generated by applying a high voltage between the first electrode 32-1 and the second electrode 32-2 as described later.

The photocatalyst can be supported on the surface of the carrier by a known method. The form of supporting the photocatalyst on the surface of the carrier is not particularly limited. The photocatalyst may be disposed as a photocatalyst layer on the surface of the carrier or may be arranged in particulate form.

A case in which the photocatalyst is particulate is preferred because a surface area becomes large when the photocatalyst is supported on the surface of the carrier. When the photocatalyst is particulate, the particle diameter of the photocatalyst is not particularly limited but is typically 1 nm to 100 nm and preferably 5 nm to 40 nm. A case in which the particle diameter is within the above range is preferred because the specific surface area of the photocatalyst is large.

The specific surface area of the photocatalyst is preferably 100 to 300 m²/g. When the specific surface area of the photocatalyst is within the range described above, the ratio of contact between the amino group-containing compound contained in the CO₂-removed exhaust gas 28 and the photocatalyst can be enhanced, and therefore, the efficiency of decomposing the amino group-containing compound by the photocatalyst can be enhanced.

The photocatalyst may be supported on the surface of the carrier as a mixture (mixture for forming photocatalytic unit) including an adsorbent which adsorbs water. As a result, a photocatalytic reaction unit including the photocatalyst and the adsorbent is supported on the surface of the carrier.

For example, at least one selected from zeolite, active carbon, silica gel, and activated alumina is used as the adsorbent. The pore diameter of the adsorbent is typically 20 Å or less, preferably 10 Å or less, and more preferably 3 Å to 10 Å. A case in which the pore diameter of the adsorbent is within the range described above is preferred because moisture in gas is adsorbed in the pore diameter of the adsorbent to adjust the humidity of the gas, and therefore, the amount of discharge light generated is large as described later, when discharge light is generated between the first electrode 32-1 and the second electrode 32-2. When the pore diameter of the adsorbent is within the range described above, the water adsorption retentivity of the adsorbent is inhibited from deteriorating, and photocatalyst performance is precluded from being affected by a change in humidity in gas.

A case in which the photocatalytic reaction unit comprises the adsorbent in an amount of typically 10 mass % or less, preferably 1 mass % to 10 mass %, and more preferably 2 mass % to 5 mass % with respect to the photocatalyst is preferred because a decrease in humidity in gas causes an increase in the amount of discharge light generated between the first electrode 32-1 and the second electrode 32-2 and therefore enables the photocatalyst performance to be enhanced.

The relative density of the photocatalytic reaction unit with respect to the theoretical density of the mixture for forming a photocatalytic unit is typically 85% to 95% and preferably 86% to 91%. The theoretical density of the mixture for forming a photocatalytic unit means a density when the mixture for forming a photocatalytic unit has the densest structure. The relative density with respect to the theoretical density is a relative density on the assumption that the theoretical density is 100%. A relative density of less than 100% shows that a gap is generated in the mixture for forming a photocatalytic unit. In a case in which the photocatalytic reaction unit has a relative density of 85% to 95%, the strength of the photocatalytic reaction unit can be prevented from decreasing, and therefore, the photocatalytic reaction unit can be prevented from peeling from the carrier. In addition, the case is preferred because the structure of the photocatalytic reaction unit becomes moderately sparse, and an organic substance and water in the CO₂-removed exhaust gas 28 easily enter a gap in the photocatalytic reaction unit, thereby enhancing photocatalyst performance.

The photocatalyst or the photocatalytic reaction unit is allowed to be supported on the surface of the carrier including the gap through which air can pass, whereby the catalytic unit 31 is formed to have a structure through which air can pass.

The open porosity of the catalytic unit 31 is approximately equal to the open porosity of the carrier and is commonly 60 to 90%. When the open porosity of the catalytic unit 31 is within the range described above, a surface area can be increased while reducing a pressure loss, and therefore, the efficiency of decomposing the amino group-containing compound in the CO₂-removed exhaust gas 28 by the photocatalyst can be allowed to be favorable while passing the CO₂-removed exhaust gas 28.

The first electrode 32-1 and the second electrode 32-2 are formed of a material having conductivity. Electrodes having plate shapes, cylindrical shapes, mesh shapes, honeycomb structures, and the like can be used as the first electrode 32-1 and the second electrode 32-2. Because the first electrode 32-1 and the second electrode 32-2 are disposed to come into contact with the CO₂-removed exhaust gas 28 in the absorption tower 11, it is preferable that the first electrode 32-1 and the second electrode 32-2 have shapes through which air can pass, such as honeycomb structures.

The one first electrode 32-1 and the one second electrode 32-2 are disposed on the periphery of the catalytic unit 31. However, plural first electrodes 32-1 and plural second electrodes 32-2 may be disposed.

The first electrode 32-1 and the second electrode 32-2 are connected to a power supply unit 33 through a wiring line 34

The power supply unit 33 applies a high voltage to the portion between the first electrode 32-1 and the second electrode 32-2 through the wiring line 34. The power supply unit 33 that can apply a high voltage to the portion between the first electrode 32-1 and the second electrode 32-2 to be capable of generating discharge light is used. Examples of the power supply unit 33 used comprise high-frequency high-voltage power supplies, high-pressure pulse generating circuits, and high-voltage direct-current power supplies. The power supply unit 33 applies, for example, a voltage of 1 to 20 kV to the first electrode 32-1 and the second electrode 32-2.

When a high voltage is applied to the portion between the first electrode 32-1 and the second electrode 32-2 by the power supply unit 33, corona discharge is generated between the electrodes to achieve a (thermally) non-equilibrium plasma state in which electron energy is high while the temperatures of ions and neutral particles are low. As a result, discharge light is generated. Discharge light refers to light generated by corona discharge. As discharge light generated between the first electrode 32-1 and the second electrode 32-2, discharge light having a wavelength at which a photocatalyst generates a photocatalytic reaction is used. Commonly, ultraviolet light having a wavelength of 10 nm to 400 nm or the like is used as discharge light. When discharge light is generated between the first electrode 32-1 and the second electrode 32-2, the photocatalyst generates a photocatalytic reaction by the discharge light, and air in the CO₂-removed exhaust gas 28 in the absorption tower 11 is partly oxidized to produce ozone (O₃) and the like.

Particularly in air, strong light is emitted at a wavelength of around 340 to 380 nm by corona discharge from the energy level of nitrogen which makes up about 80% of air. When the photocatalyst is formed of titanium oxide, irradiation of titanium oxide with ultraviolet light which is light having a wavelength of 380 nm or less causes titanium oxide to react with water and oxygen to produce active enzyme species having high oxidizability, such as hydroxyl radicals (.OH) and superoxide ions (O₂⁻). Because the wavelength of discharge light generated between the first electrode 32-1 and the second electrode 32-2 falls within a wavelength range in which titanium oxide can be activated, it is preferable to use titanium oxide for the photocatalyst. When titanium oxide is used for the photocatalyst, it is possible to decompose an amino group-containing compound adsorbed in the photocatalyst by allowing the photocatalyst to exhibit a catalytic activity under discharge light generated between the first electrode 32-1 and the second electrode 32-2 as a light source, and therefore, the amino group-containing compound can be removed from the CO₂-removed exhaust gas 28 to purify the CO₂-removed exhaust gas 28.

There are circumstances under which the exhaust gas 21 is a combustion exhaust gas discharged from a boiler or the like and therefore often contains NOx (nitrogen oxide) and SOx (sulfur oxide). In this case, in the CO₂ absorption unit 24 of the absorption tower 11, NOx and SOx in the exhaust gas 21 are absorbed in the lean solution 22 to produce nitric acid, nitrous acid, sulfurous acid, sulfuric acid, and the like. In many cases, produced nitric acid, nitrous acid, sulfurous acid, and sulfuric acid form a salt with the amino group-containing compound in the absorbing liquid. For example, when the lean solution 22 contains a secondary amine, the secondary amine reacts with nitrous acid to produce nitrosamine, as described in the following formula. Further, nitramine is produced by oxidation of the nitrosamine. The nitrosamine accompanied by the CO₂-removed exhaust gas 28 is released in the absorption tower 11 or into atmosphere and is oxidized to produce the nitramine. Among amino group-containing compounds, in particular, such nitrosamine and nitramine possess high toxicity. Because these amino group-containing compounds are removed in the purification unit 27, the amino group-containing compounds can be inhibited from being accompanied by the CO₂-removed exhaust gas 28 and from being discharged into atmosphere.

R₁R₂NH+HNO₂→R₁R₂N—NO+H₂O (1)

In the present embodiment, the photocatalyst causes the photocatalytic reaction by discharge light in the purification unit 27, thereby decomposing the amino group-containing compound, and therefore, formation of the carrier using such an insulating substance as described above is important for improving the efficiency of decomposing the amino group-containing compound. In the catalytic unit 31, in a case in which the carrier is formed of such an insulating substance as described above, discharge light can be generated from the carrier in the catalytic unit 31 because creeping discharge is generated along the surface of the carrier when a high voltage is applied to the portion between the first electrode 32-1 and the second electrode 32-2 to generate discharge light. Therefore, the whole photocatalyst supported on the carrier can be irradiated with discharge light. As a result, the catalytic unit 31 can improve the efficiency of purifying the CO₂-removed exhaust gas 28 because of improving the efficiency of decomposing an amino group-containing compound.

The adsorptivity of the amino group-containing compound into the pores of the carrier can be improved when the carrier is formed to be porous. When a high voltage is applied to the portion between the first electrode 32-1 and the second electrode 32-2 to generate discharge light, the interiors of porous pores become in a low-temperature plasma state, and therefore, discharge light can also be generated inside the pores of the catalytic unit 31. Thus, the amino group-containing compound adsorbed in the pores of the catalytic unit 31 can be decomposed in a state in which the amino group-containing compound is adsorbed in the pores of the carrier. Therefore, the catalytic unit 31 can further improve the efficiency of decomposing an amino group-containing compound and can further improve the efficiency of purifying the CO₂-removed exhaust gas 28.

The distance between the first electrode 32-1 and the second electrode 32-2 is preferably within a range of 1 to 2 cm and more preferably 1.2 to 1.5 cm. When the distance between the first electrode 32-1 and the second electrode 32-2 is within the range described above, discharge light can be generated in a porous space unit when the carrier is formed to be porous.

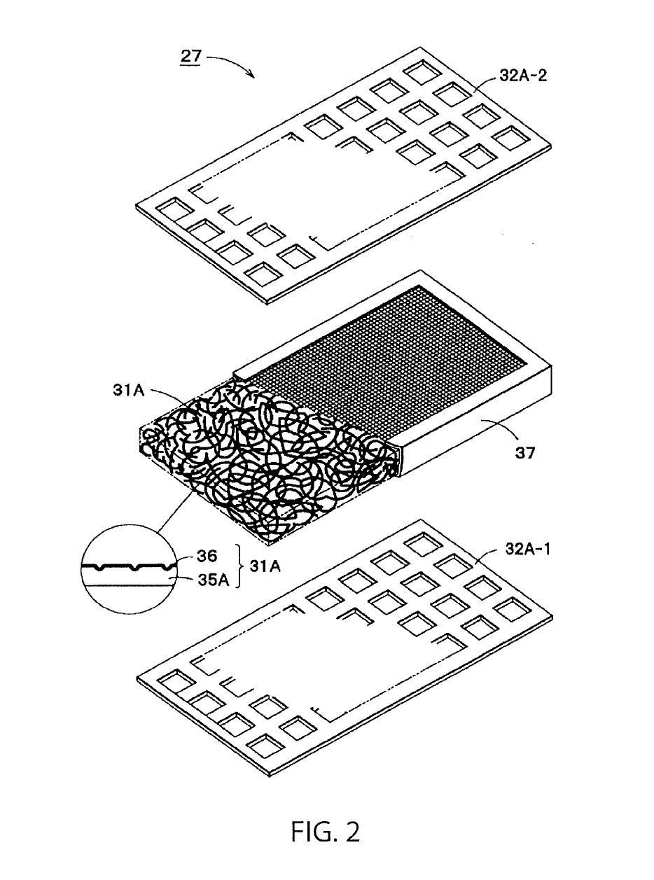

In the present embodiment, the catalytic unit 31 is arranged to be pinched between the first electrode 32-1 and the second electrode 32-2 in the gas flow direction of the CO₂-removed exhaust gas 28 in the absorption tower 11, and therefore, it is preferable that the purification unit 27 is formed so that air can pass through the catalytic unit 31, the first electrode 32-1, and the second electrode 32-2. For example, the purification unit 27 can be formed of a catalytic unit 31A formed of a fiber aggregate and a first electrode 32A-1 and a second electrode 32A-2 having a mesh shape, as illustrated in FIG. 2. Because a carrier 35A is formed of the fiber aggregate, a photocatalyst 36 is supported on a surface of the carrier, whereby the catalytic unit 31A can be formed to have the shape of the fiber aggregate. It is preferable that the catalytic unit 31A is housed in a housing unit 37 including air holes.

Because the catalytic unit 31A is formed to have a three-dimensional mesh structure, the surface area of the carrier 35A coming into contact with the CO₂-removed exhaust gas 28 can be increased. Therefore, the catalytic unit 31A can improve the efficiency of the contact of the amino group-containing compound contained in the CO₂-removed exhaust gas 28 with the photocatalyst while allowing the CO₂-removed exhaust gas 28 to pass through the gaps of the carrier 35A.

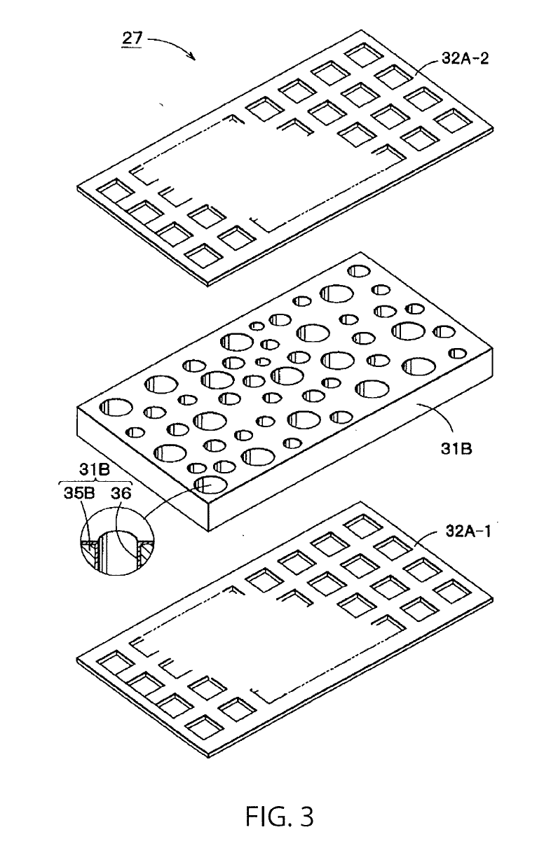

The purification unit 27 can be formed of, for example, a catalytic unit 31B formed to have a honeycomb structure and the first electrode 32A-1 and the second electrode 32A-2 having a mesh shape, as illustrated in FIG. 3. A carrier 35B is formed to have a honeycomb structure, and the photocatalyst 36 is formed on a surface of the carrier, whereby the catalytic unit 31B can be formed to have a honeycomb structure. Because the catalytic unit 31B has the honeycomb structure, the surface area of the carrier 35B coming into contact with the CO₂-removed exhaust gas 28 can be increased. Therefore, the catalytic unit 31B can improve the efficiency of the contact of the amino group-containing compound contained in the CO₂-removed exhaust gas 28 with the photocatalyst.

In the present embodiment, a pair of electrodes including the first electrode 32-1 and the second electrode 32-2 is used as the activation member. However, the catalytic unit 31 may be irradiated with ultraviolet light using an ultraviolet (UV) lamp instead of the pair of electrodes to activate the photocatalyst 36.

In this case, a known power supply for supplying a current to the UV lamp is used as the power supply unit 33. The combination of a pair of electrodes including the first electrode 32-1 and the second electrode 32-2 and an UV lamp may be used as the activation member.

In such a manner, the CO₂-removed exhaust gas 28 is purified in the purification unit 27 and then discharged as a purified gas 38 from the upper portion of the absorption tower 11 to the outside.

As illustrated in FIG. 1, the rich solution 23 stored in the lower portion of the absorption tower 11 is discharged from the lower portion of the absorption tower 11, passes through a rich solution supply line L11, is pressurized by a pump 39 disposed in the rich solution supply line L11, is subjected to heat exchange with the lean solution 22 regenerated in the regeneration tower 12 in a heat exchanger 40, and is then supplied to the regeneration tower 12. A known heat exchanger such as a plate heat exchanger or a shell & tube heat exchanger can be used as the heat exchanger 40.

The regeneration tower 12 is a tower in which CO₂ is separated from the rich solution 23, CO₂ is released from the rich solution 23, and the rich solution 23 is regenerated as the lean solution 22. The regeneration tower 12 comprises liquid dispersers 41-1 and 41-2, fill layers 42-1 and 42-2 for enhancing the efficiency of gas-liquid contact, and demisters 43 and 44 in the tower. The rich solution 23 supplied from the upper portion of the regeneration tower 12 into the tower is supplied into the tower by the liquid disperser 41-1, falls from the upper portion of the regeneration tower 12, and is heated by water vapor (steam) supplied from the lower portion of the regeneration tower 12 while passing through the fill layer 42-1. The water vapor is generated by heat exchange of the lean solution 22 with saturated steam 46 in a regeneration superheater (reboiler) 45. The rich solution 23 is heated by the water vapor, whereby most of CO₂ contained in the rich solution 23 is desorbed, and the lean solution 22 from which almost all CO₂ is removed at about the time when the rich solution 23 reaches the lower portion of the regeneration tower 12.

Part of the lean solution 22 stored in the lower portion of the regeneration tower 12 is discharged from the lower portion of the regeneration tower 12 through a lean solution circulation line L21, heated by the reboiler 45, and then resupplied into the regeneration tower 12. In this case, the lean solution 22 is heated by the reboiler 45, to generate water vapor, and remaining CO₂ is released as a CO₂ gas. The generated water vapor and CO₂ gas are returned into the regeneration tower 12, pass through the fill layer 42-1 of the regeneration tower 12, move upward, and heat the rich solution 23 flowing down. As a result, CO₂ in the lean solution 22 is released as a CO₂ gas from the interior of the regeneration tower 12.

A method of releasing CO₂ from the rich solution 23 to perform reproduction as the lean solution 22 in the regeneration tower 12 is not limited to a method of performing countercurrent contact between the rich solution 23 and water vapor in the fill layer 42-1 to heat the rich solution 23 but may be, for example, a method of heating the rich solution 23 to release CO₂, and the like.

The CO₂ gas released from the lean solution 22 is discharged, together with water vapor simultaneously evaporating from the lean solution 22, from the upper portion of the regeneration tower 12. A mixed gas 51 containing the CO₂ gas and water vapor passes through a CO₂ discharge line L22 and is cooled by cooling water 53 in a cooler 52, and water vapor condenses into water. A mixed fluid 54 containing the condensed water and the CO₂ gas is supplied to a gas/liquid separator 55, a CO₂ gas 56 is separated from water 57 in the gas/liquid separator 55, and the CO₂ gas 56 is discharged from a recovery CO₂ discharge line L23 to the outside. The water 57 is drawn out from the lower portion of the gas/liquid separator 55, pressurized as reflux water by a pump 58, and supplied to the upper portion of the regeneration tower 12 through a reflux water supply line L24.

The lean solution 22 stored in the lower portion of the regeneration tower 12 is discharged as an absorbing liquid from the lower portion of the regeneration tower 12 into a lean solution discharge line L12, subjected to heat exchange with the rich solution 23 in the heat exchanger 40, and cooled. Then, the lean solution 22 is pressurized by a pump 47, cooled by cooling water 49 in a cooler 48, and supplied as an absorbing liquid to the absorption tower 11.

As described above, the purification unit 27 is comprised in the absorption tower 11 in the CO₂ recovery apparatus 10A. The purification unit 27 can decompose the amino group-containing compound in the CO₂-removed exhaust gas 28 by activating the photocatalyst by discharge light generated by corona discharge while the CO₂-removed exhaust gas 28 can pass through the gaps of the carrier. Therefore, the CO₂ recovery apparatus 10A can remove the amino group-containing compound contained in the CO₂-removed exhaust gas 28 to purify the CO₂-removed exhaust gas in the purification unit 27 and can therefore further decrease the concentration of the amino group-containing compound released into atmosphere. In particular, according to the present embodiment, for example, 90% or more of a highly-toxic amino group-containing compound such as nitrosamine or nitramine can be decomposed in the purification unit 27.

According to the present embodiment, the photocatalyst is disposed and formed in the purification unit 27, and therefore, the height of the absorption tower 11 can be decreased while simplifying the construction of the purification unit 27. In particular, according to the present embodiment, the height of purification unit 27 can be decreased to, for example, one-tenth or less of that in comparison with the case of cleaning the CO₂-removed exhaust gas 28 with water or an acid solution.

Further, according to the present embodiment, the photocatalyst can be continuously used without exchanging the photocatalyst, and therefore, the CO₂ recovery apparatus 10A enables the amino group-containing compound contained in the CO₂-removed exhaust gas 28 to be stably removed in the purification unit 27 for a long term.

According to the present embodiment, energy necessary for removing the amino group-containing compound contained in the CO₂-removed exhaust gas 28 can be reduced in the purification unit 27 because the amino group-containing compound in CO₂-removed exhaust gas 28 can be decomposed in the purification unit 27 only by applying a high voltage to the portion between the first electrode 32A-1 and the second electrode 32A-2 to irradiate the photocatalyst with discharge light generated by corona discharge. As a result, a cost required for removing the amino group-containing compound can be intended to be reduced.

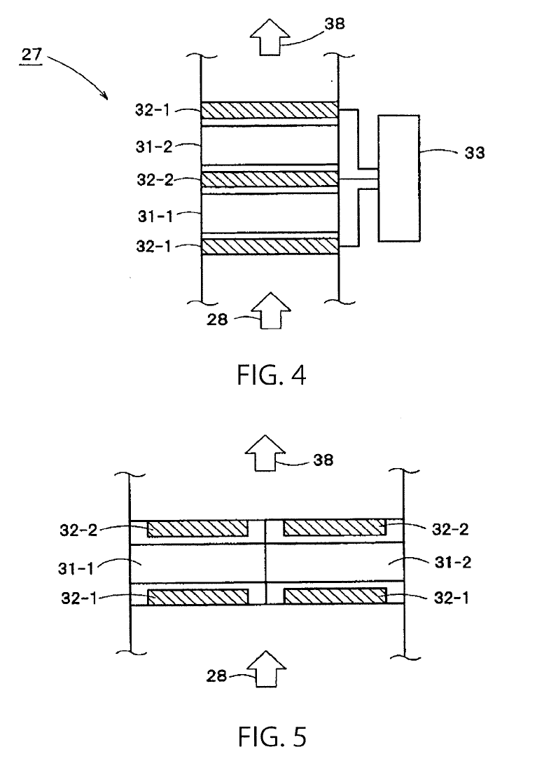

In the present embodiment, the catalytic unit 31 is formed in one row. However, plural catalytic units 31 may be arranged in series or may be arranged in one or more columns in parallel. Such plural catalytic units 31 may be arranged in parallel, in which one or more catalytic units may be arranged in each column. For example, as illustrated in FIG. 4, catalytic units 31-1 and 31-2 are disposed in two rows, and a first electrode 32-1 may be further arranged in the downstream side of the catalytic unit 31-2 in the gas flow direction of the CO₂-removed exhaust gas 28. As a result, the area of the contact of the CO₂-removed exhaust gas 28 with the photocatalyst can be increased, and therefore, the efficiency of removing the amino group-containing compound in the CO₂-removed exhaust gas 28 in the purification unit 27 can be improved. As a result, the efficiency of purifying a CO₂-removed exhaust gas is improved, and therefore, the concentration of amine released into atmosphere can be decreased.

As illustrated in FIG. 5, the catalytic units 31-1 and 31-2 may be arranged in parallel. Similarly in such a case, the area of the contact of the CO₂-removed exhaust gas 28 with the photocatalyst can be increased, and therefore, the efficiency of removing the amino group-containing compound in the CO₂-removed exhaust gas 28 in the purification unit 27 can be improved. As a result, the efficiency of purifying a CO₂-removed exhaust gas is improved, and therefore, the concentration of amine released into atmosphere can be further decreased.

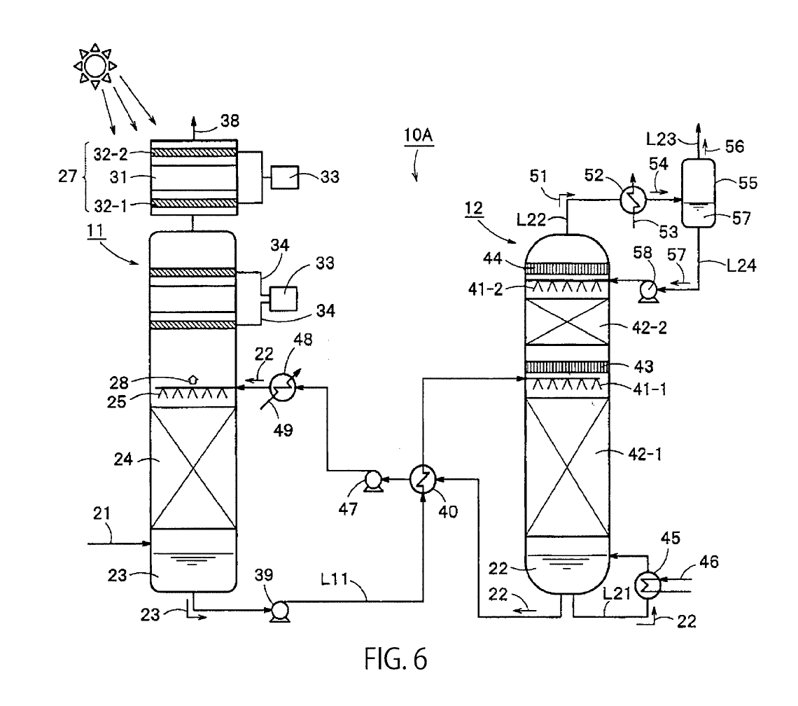

In the present embodiment, the purification unit 27 is disposed in the absorption tower 11. However, the purification unit 27 may be disposed outside the absorption tower 11 to supply the CO₂-removed exhaust gas 28, discharged from the absorption tower 11, to the purification unit 27, as illustrated in FIG. 6. As a result, not only discharge light but also sunlight can be used as light with which the catalytic unit 31 is irradiated, and therefore, the power supply unit 33 can be stopped to reduce energy necessary for activating the photocatalyst during the daytime when sunlight is provided.

### Second Embodiment

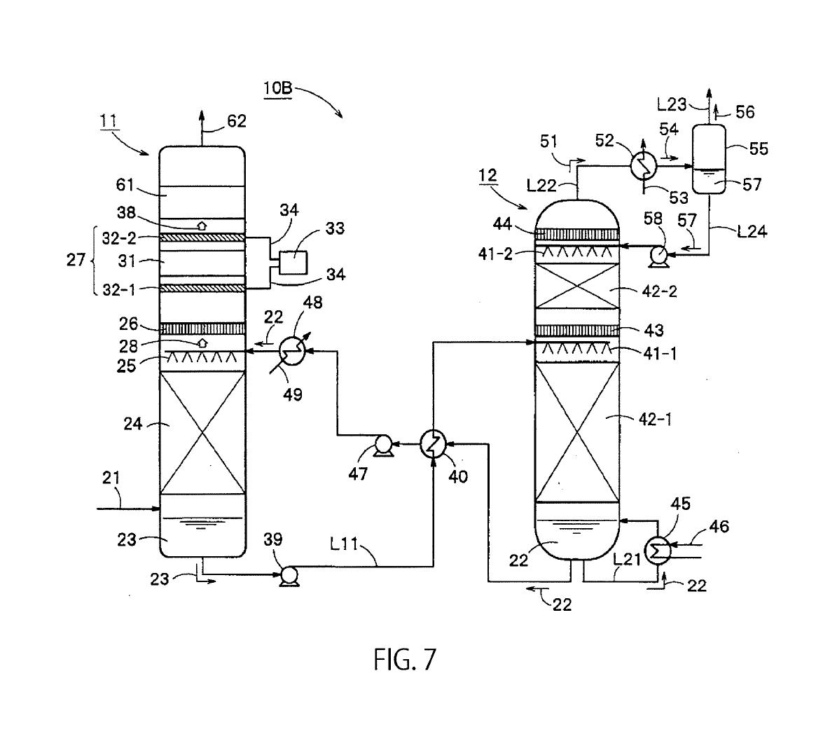

A CO₂ recovery apparatus according to a second embodiment will be described with reference to the drawings. The same sign will be applied to a member having the same function as that in the embodiment described above, and the detailed description thereof will be omitted. FIG. 7 is a schematic view illustrating the construction of the CO₂ recovery apparatus according to the second embodiment. As illustrated in FIG. 7, the CO₂ recovery apparatus 10B comprises an ozone decomposition unit 61 in an absorption tower 11. The ozone decomposition unit 61 is disposed in a portion closer to a downstream side in the flow direction of a CO₂-removed exhaust gas 28 than a purification unit 27 and is disposed in an upper tower side in the absorption tower 11.

The ozone decomposition unit 61 is formed so that a base contains an ozone decomposition catalyst that decomposes ozone in a purified gas 38 into active oxygen and that decomposes an amino group-containing compound remaining in the purified gas 38. The base is formed to comprise the ozone decomposition catalyst and to comprise gaps through which air can pass. For example, a porous body having a honeycomb structure or the like is used as the base. Examples of the ozone decomposition catalyst comprise manganese oxide.

When the CO₂-removed exhaust gas 28 passes through the purification unit 27, ozone is produced in the CO₂-removed exhaust gas 28 by discharge light generated in the purification unit 27 as described above, and therefore, ozone exists in the purified gas 38 passing through the purification unit 27. Ozone typically remains without being decomposed in air for around several hours. Therefore, a substantial amount of ozone exists in the purified gas 38 that has passed through the purification unit 27. When the purified gas 38 is supplied to the ozone decomposition unit 61, ozone existing in the purified gas 38 is temporarily adsorbed on a surface of the ozone decomposition catalyst to decompose the ozone on the surface of the ozone decomposition catalyst and to produce oxygen radicals having high chemical activity during the decomposition of the ozone in the ozone decomposition unit 61. The oxygen radicals decompose an amino group-containing compound remaining in the purified gas 38. Further, the oxygen radicals naturally vanish in a very short time. Therefore, a purified gas 62 that has passed through the ozone decomposition unit 61 becomes a gas that substantially contains neither amino group-containing compounds nor oxygen radicals.

Thus, according to the present embodiment, the CO₂ recovery apparatus 10B can decompose ozone in the purified gas 38 in the ozone decomposition unit 61 and can decompose and remove an amino group-containing compound remaining in the purified gas 38 using oxygen radicals generated by the decomposition of the ozone, and therefore, the concentration of amine released into atmosphere can be further reduced.

### Third Embodiment

A CO₂ recovery apparatus according to a third embodiment will be described with reference to the drawings.

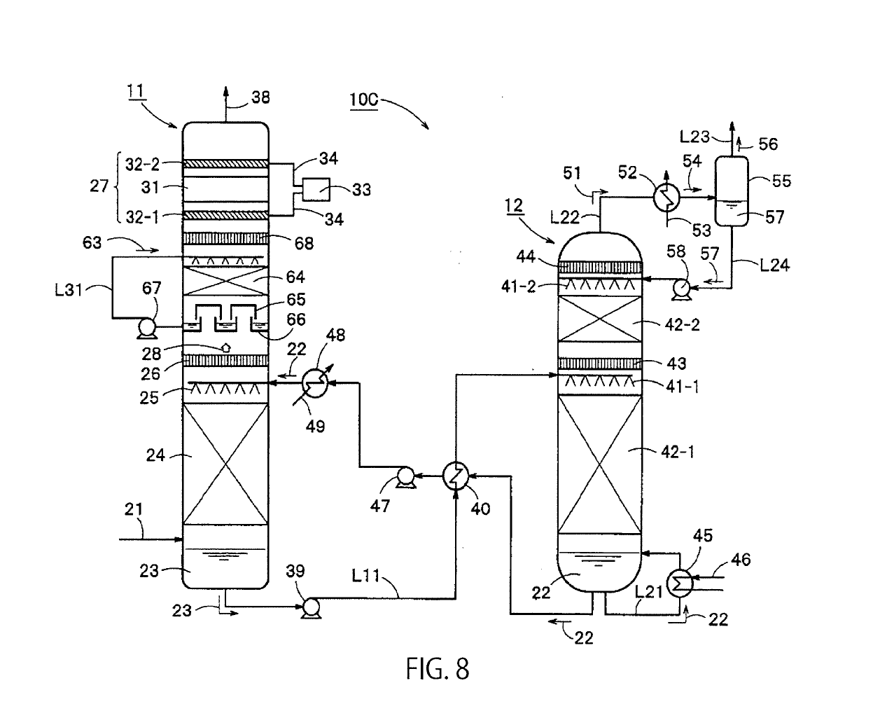

The same sign will be applied to a member having the same function as that in the embodiment described above, and the detailed description thereof will be omitted. FIG. 8 is a schematic view illustrating the construction of the CO₂ recovery apparatus according to the third embodiment. As illustrated in FIG. 8, the CO₂ recovery apparatus 10C comprises a water cleaning unit 64 that removes an amino group-containing compound contained in a CO₂-removed exhaust gas 28 using cleaning water 63. The water cleaning unit 64 is disposed between a CO₂ absorption unit 24 and a purification unit 27.

The CO₂-removed exhaust gas 28 moves upward toward the water cleaning unit 64 through a tray 65 and comes into gas-liquid contact with the cleaning water 63 supplied from the top side of the water cleaning unit 64 in the water cleaning unit 64, whereby an amino group-containing compound accompanied by the CO₂-removed exhaust gas 28 is recovered in the cleaning water 63.

The cleaning water 63 stored in a liquid storage unit 66 in the tray 65 is circulated to the water cleaning unit 64 through a cleaning water circulation line L31 by a pump 67 to bring the cleaning water 63 into gas-liquid contact with the CO₂-removed exhaust gas 28 in the water cleaning unit 64. The cleaning water 63 is commonly circulated at a temperature of 20 to 40° C.

Moisture in the gas is removed in the demister 68, and the CO₂-removed exhaust gas 28 that has passed through the water cleaning unit 64 is then supplied to the purification unit 27.

The amino group-containing compound contained in the CO₂-removed exhaust gas 28 partly contains a degraded amine having deteriorated CO₂ absorption performance. The degraded amine is, e.g., an amine produced by deteriorating the amino group-containing compound used as the principal component of an absorbing liquid 22 by decomposition or denaturation in the process of circulating and using the absorbing liquid 22 through an absorption tower 11 and a regeneration tower 12. Examples of the degraded amine include nitrosamine and nitramine which are produced by gas-liquid contact between the lean solution 22 and an exhaust gas 21 and by reaction of the amino group-containing compound with nitrous acid contained in the exhaust gas, as described above. When monoethanolamine is used as the absorbing liquid 22, a nitroso-based amine such as ethylamine, 2-(2-aminoethylamino) ethanol (HEEDA), or nitrosodimethylamine is produced as the degraded amine. The amino group-containing compound contained in the CO₂-removed exhaust gas 28 contains an amine of which the CO₂ absorption performance is not deteriorated or is hardly deteriorated, as well as the degraded amine. In the present specification, the amine of which the CO₂ absorption performance is not deteriorated or is hardly deteriorated, other than the degraded amine, is referred to as a principal amine.

Because the volatility of the principal amine is lower than that of the degraded amine, the principal amine tends to be more easily recovered in the cleaning water 63 than the degraded amine in the water cleaning unit 64. In the present embodiment, the water cleaning unit 64 is disposed between the CO₂ absorption unit 24 and the purification unit 27. Therefore, most of the principal amine contained in the CO₂-removed exhaust gas 28 is recovered in the water cleaning unit 64 in advance, and the degraded amine contained in a purified gas 38 and a remaining principal amine can be then decomposed and removed in the purification unit 27.

Thus, according to the present embodiment, in the CO₂ recovery apparatus 10C, the principal amine can be recovered in the cleaning water 63 in the water cleaning unit 64, and therefore, the recovered principal amine can be reused as an absorbing liquid. In the CO₂ recovery apparatus 10C, the concentration of amine released into atmosphere can be further decreased because the degraded amine and the remaining principal amine can be decomposed and removed in the purification unit 27 as well as in the water cleaning unit 64.

### Fourth Embodiment

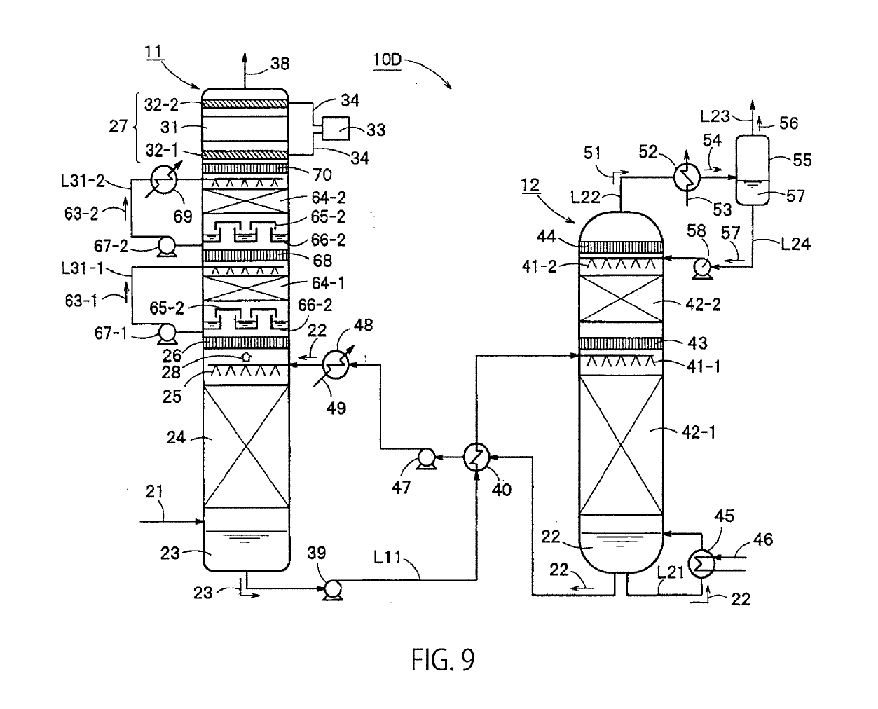

A CO₂ recovery apparatus according to a fourth embodiment will be described with reference to the drawings. The same sign will be applied to a member having the same function as that in the embodiment described above, and the detailed description thereof will be omitted. FIG. 9 is a schematic view illustrating the construction of the CO₂ recovery apparatus according to the fourth embodiment. As illustrated in FIG. 9, in the CO₂ recovery apparatus 10D, the water cleaning unit 64 of the CO₂ recovery apparatus 10C illustrated in FIG. 8 as described above is made into a first water cleaning unit 64-1 and a second water cleaning unit 64-2 of two columns, and a cleaning water circulation line L31-2 comprises a cooler (cooling unit) 69 that cools in advance second cleaning water 63-2 supplied to the water cleaning unit 64-2. The cooler 69 cools cleaning water 63 to, for example, 5 to 30° C.

A CO₂-removed exhaust gas 28 moves upward toward the first water cleaning unit 64-1 through a tray 65-1 and comes into gas-liquid contact with first cleaning water 63-1 supplied from the top side of the first water cleaning unit 64-1 in the first water cleaning unit 64-1 to recover an amino group-containing compound accompanied by the CO₂-removed exhaust gas 28 in the first cleaning water 63-1. The first cleaning water 63-1 stored in a liquid storage unit 66-1 in the tray 65-1 is circulated to the water cleaning unit 64-1 through a cleaning water circulation line L31-1 by a pump 67-1 to bring the first cleaning water 63-1 into gas-liquid contact with the CO₂-removed exhaust gas 28 in the first water cleaning unit 64-1.

Moisture in the gas is removed in a demister 68, and the CO₂-removed exhaust gas 28 that has passed through the first water cleaning unit 64-1 then moves upward toward the second water cleaning unit 64-2 through a tray 65-2. The CO₂-removed exhaust gas 28 comes into gas-liquid contact with the second cleaning water 63-2 cooled from the top side of the second water cleaning unit 64-2 in the water cleaning unit 64-2 to recover an amino group-containing compound contained in the CO₂-removed exhaust gas 28 in the second cleaning water 63-2. The second cleaning water 63-2 stored in a liquid storage unit 66-2 in the tray 65-2 is passed through the cleaning water circulation line L31-2 by a pump 67-2, and the second cleaning water 63-2 is cooled in advance by the cooler 69 and then circulated to the second water cleaning unit 64-2, to bring the second cleaning water 63-2 into gas-liquid contact with the CO₂-removed exhaust gas 28 in the second water cleaning unit 64-2.

Moisture in the gas is removed in a demister 70, and the CO₂-removed exhaust gas 28 that has passed through the second water cleaning unit 64-2 is then supplied to a purification unit 27.

By decreasing the gas temperature of the CO₂-removed exhaust gas 28 while cleaning the CO₂-removed exhaust gas 28 with water in the second water cleaning unit 64-2, the saturated vapor pressure (saturated humidity) of the CO₂-removed exhaust gas 28 is reduced to reduce the water content of the CO₂-removed exhaust gas 28. The lower the saturated humidity of the CO₂-removed exhaust gas 28 is, the more easily the discharge light is generated in the purification unit 27. Therefore, the smaller the water content of the CO₂-removed exhaust gas 28 is, the more highly the discharge effect in the purification unit 27 can be maintained, and the higher the efficiency of purifying the CO₂-removed exhaust gas 28 can become.

In particular, a principal amine tends to be more easily recovered in the first cleaning water 63-1 than a degraded amine because the volatility of the principal amine is less than that of the degraded amine. Therefore, in the present embodiment, for improving the efficiency of recovering both the principal amine and the degraded amine, it is preferable that the temperature of the second cleaning water 63-2 is allowed to be lower than that of the first cleaning water 63-1, most of the principal amine is recovered by using the first cleaning water 63-1 (for example, at 20 to 40° C.) in the first water cleaning unit 64-1, and the remaining principal amine and the degraded amine are then recovered by using the second cleaning water 63-2 (for example, at 5 to 30° C.) in the second water cleaning unit 64-2.

Thus, according to the present embodiment, in the CO₂ recovery apparatus 10D, the efficiency of removing an amino group-containing compound contained in the CO₂-removed exhaust gas 28 can be highly maintained in the purification unit 27 by decreasing the temperature of the CO₂-removed exhaust gas 28 in advance while cleaning the CO₂-removed exhaust gas 28 with water in the second water cleaning unit 64-2.

The lower the temperature of the second cleaning water 63-2 is, the higher the amount of the recovered amino group-containing compound in the CO₂-removed exhaust gas 28 can become. Thus, according to the present embodiment, the second cleaning water 63-2 cooled by the second water cleaning unit 64-2 is used in the CO₂ recovery apparatus 10D, and therefore, the amount of amine recovered by cleaning the CO₂-removed exhaust gas 28 with water in the second water cleaning unit 64-2 can be increased.

Further, the kinds of recovered amino group-containing compounds and the concentrations of the corresponding amino group-containing compounds tend to differ depending to the temperature of a medium used for cooling. According to the present embodiment, in the CO₂ recovery apparatus 10D, the kinds of amino group-containing compounds recovered in the first water cleaning unit 64-1 and the second water cleaning unit 64-2 and the concentrations of the corresponding amino group-containing compounds are different because the temperatures of the first cleaning water 63-1 and the second cleaning water 63-2 are different. For example, in the present embodiment, most of the principal amine is recovered in the first water cleaning unit 64-1, and the degraded amine is recovered in the second water cleaning unit 64-2. Therefore, the recovery of the principal amine and the treatment of the degraded amine can be efficiently performed from the amino group-containing compounds recovered in the first cleaning water 63-1 and the second cleaning water 63-2 in the first water cleaning unit 64-1 and the second water cleaning unit 64-2.

Note that, in the present embodiment, the second cleaning water 63-2 is cooled, but the first cleaning water 63-1 may be cooled. It is also acceptable to dispose only the second water cleaning unit 64-2 without disposing the first water cleaning unit 64-1 and to use only the second cleaning water 63-2 for cleaning the CO₂-removed exhaust gas 28 with water.

### Fifth Embodiment

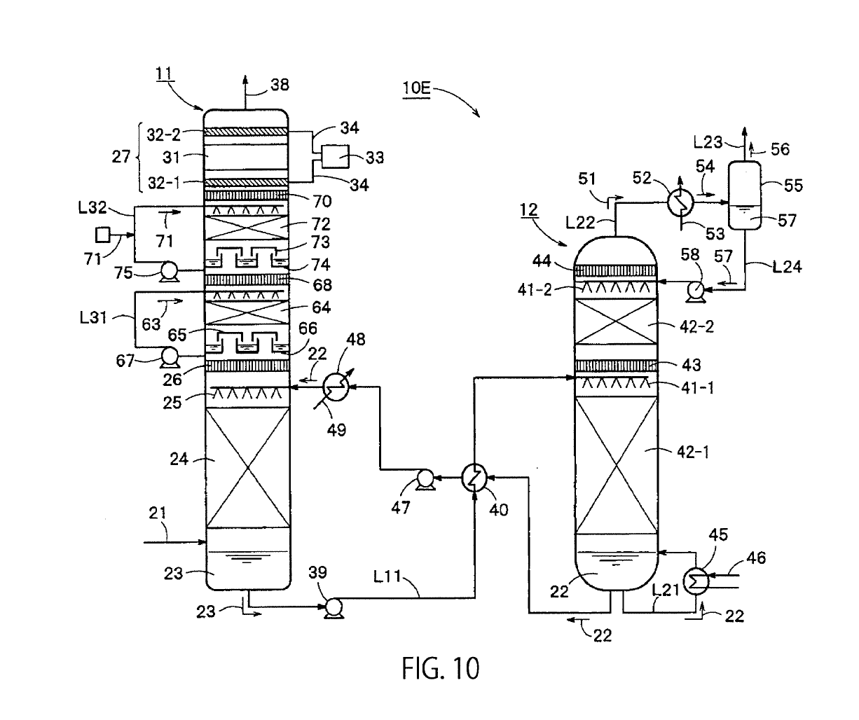

A CO₂ recovery apparatus according to a fifth embodiment will be described with reference to the drawings. Note that the same sign will be applied to a member having the same function as that in the embodiment described above, and the detailed description thereof will be omitted. FIG. 10 is a schematic view illustrating the construction of the CO₂ recovery apparatus according to the fifth embodiment. As illustrated in FIG. 10, the CO₂ recovery apparatus 10E comprises an acid cleaning unit 72 which brings a CO₂-removed exhaust gas 28 into contact with an acid solution 71 to remove an amino group-containing compound in the CO₂-removed exhaust gas 28. The acid cleaning unit 72 is disposed between a purification unit 27 and a water cleaning unit 64.

The CO₂-removed exhaust gas 28 moves upward toward the acid cleaning unit 72 through a tray 73 and comes into gas-liquid contact with the acid solution 71 supplied from the top side of the acid cleaning unit 72 in the acid cleaning unit 72, whereby an amino group-containing compound accompanied by the CO₂-removed exhaust gas 28 is recovered in the acid solution 71.

The acid solution 71 stored in a liquid storage unit 74 in the tray 73 is circulated to the acid cleaning unit 72 through an acid solution circulation line L32 by a pump 75 to bring the acid solution 71 into gas-liquid contact with the CO₂-removed exhaust gas 28 in the acid cleaning unit 72.

An aqueous solution including sulfuric acid, hydrochloric acid, phosphoric acid, boric acid, carbonic acid, nitric acid, or oxalic acid, or two or more thereof is preferably used as the acid solution 71. Of these, it is preferable to use sulfuric acid from the viewpoint of the efficiency of recovering both of a principal amine and a degraded amine.

It is essential only that the acid cleaning unit 72 is in a portion closer to an upstream side in the flow direction of the CO₂-removed exhaust gas 28 than the purification unit 27. It is preferable to dispose the acid cleaning unit 72 between the water cleaning unit 64 and the purification unit 27. Because the acid solution 71 has the higher efficiency of recovering the degraded amine than water, the degraded amine that has not been able to be recovered in the water cleaning unit 64 can be recovered in the acid cleaning unit 72 while recovering all or most of the principal amine in the water cleaning unit 64 by disposing the acid cleaning unit 72 between the water cleaning unit 64 and the purification unit 27. Therefore, the burden of decomposing and removing the degraded amine contained in the purified gas 38 and a remaining principal amine in the purification unit 27 can be reduced by recovering in advance the degraded amine that has not been able to be recovered in the water cleaning unit 64 in the acid cleaning unit 72.

Thus, according to the present embodiment, in the CO₂ recovery apparatus 10E, the effect of decreasing the concentration of an amine released into atmosphere can be further enhanced because the principal amine can be recovered in the water cleaning unit 64 and can be reused as an absorbing liquid, and the degraded amine and the remaining principal amine can be decomposed and removed in the acid cleaning unit 72 and the purification unit 27.

The present embodiment comprises both the water cleaning unit 64 and the acid cleaning unit 72. However, it is also acceptable to dispose only the acid cleaning unit 72 without disposing the water cleaning unit 64.

### Sixth Embodiment

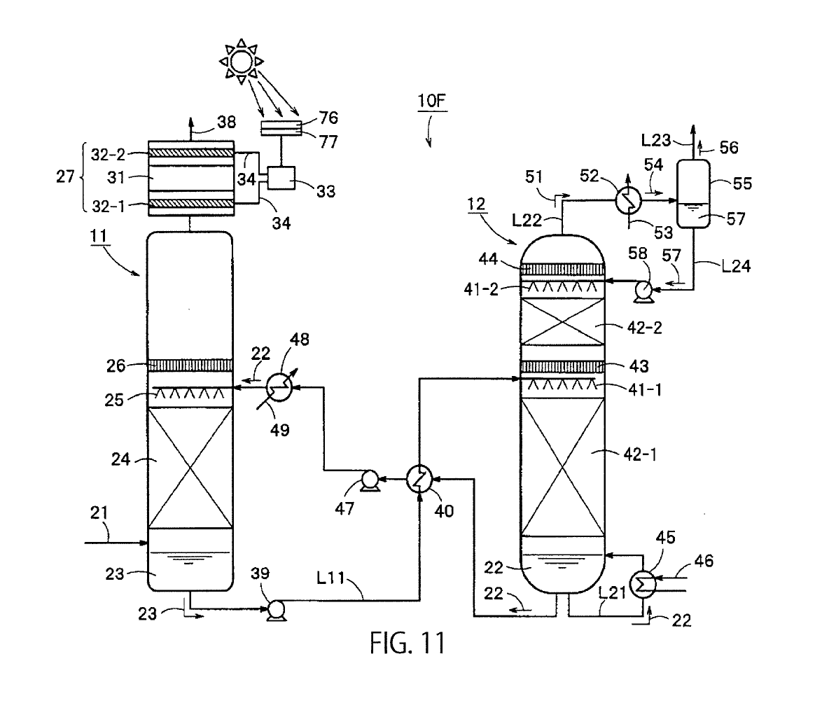

A CO₂ recovery apparatus according to a sixth embodiment will be described with reference to the drawings. Note that the same sign will be applied to a member having the same function as that in the embodiment described above, and the detailed description thereof will be omitted. FIG. 11 is a schematic view illustrating the construction of the CO₂ recovery apparatus according to the sixth embodiment. As illustrated in FIG. 11, a purification unit 27 is disposed outside an absorption tower 11, in the CO₂ recovery apparatus 10F comprising: an electricity generation unit 76 that obtains power from sunlight; and electricity accumulation unit 77 that accumulates the power provided by the electricity generation unit 76. For example, a photovoltaic power generation panel or the like is used as the electricity generation unit 76. For example, a secondary battery, a lithium ion battery, a nickel-hydrogen battery, or the like can be used as the electricity accumulation unit 77.

The CO₂ recovery apparatus 10F can allow the electricity accumulation unit 77 to accumulate electricity generated by the electricity generation unit 76 during the daytime and can use electricity accumulated during the nighttime as electricity for a power supply unit 33.

Thus, according to the present embodiment, the CO₂ recovery apparatus 10F can stop the power supply unit 33 or can reduce the use of the power supply unit 33 by utilizing sunlight during the daytime, and can reduce a power necessary for the power supply unit 33 by using electricity accumulated in the electricity accumulation unit 77 during the nighttime. Therefore, the CO₂ recovery apparatus 10F can efficiently purify a CO₂-removed exhaust gas 28 while saving electricity.

In the present embodiment, sunlight is used as natural energy. However, wind power, water power, or the like may be used. A wind mill can be used in the electricity generation unit 76 when the power is obtained from wind power, and a water turbine can be used in the electricity generation unit 76 when the power is obtained from water power. In addition to sunlight, either wind power or water power may be used in combination.

### Seventh Embodiment

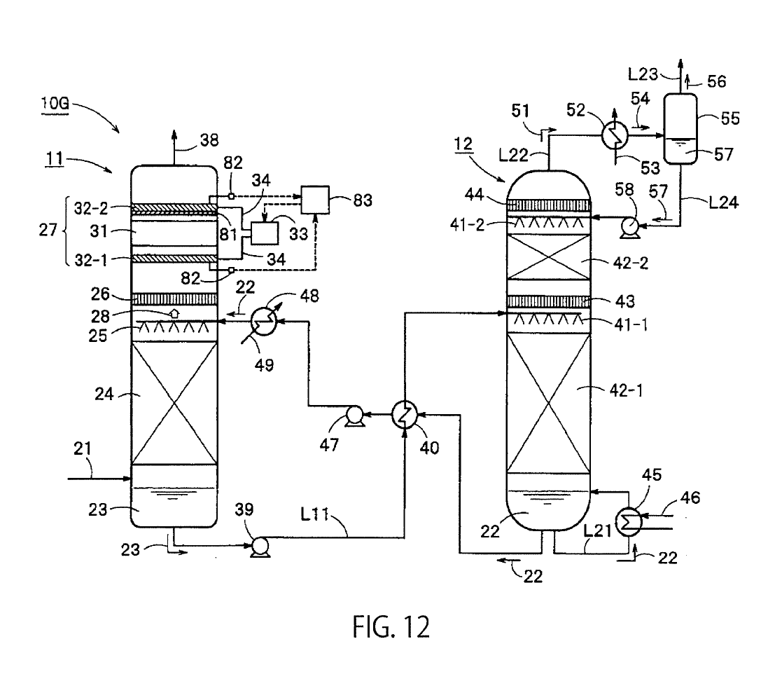

A CO₂ recovery apparatus according to a seventh embodiment will be described with reference to the drawings. Note that the same sign will be applied to a member having the same function as that in the embodiment described above, and the detailed description thereof will be omitted. FIG. 12 is a schematic view illustrating the construction of the CO₂ recovery apparatus according to the seventh embodiment. As illustrated in FIG. 12, the CO₂ recovery apparatus 10G comprises: a dielectric 81 disposed on a surface, facing a catalytic unit 31, of a second electrode 32-2; a measurement unit 82 connected to the first electrode 32-1 and a second electrode 32-2; and a controlling unit 83.

The dielectric 81 is disposed to coat the surface, facing the catalytic unit 31, of the second electrode 32-2. The dielectric 81 can be formed of a known dielectric material. For example, an inorganic insulator such as TiO₂, ZrO₂, Al₂O₃, SiO₂, HfO₂, or mica, an organic insulator such as polyimide, glass epoxy, or rubber, or the like can be used for the dielectric 81. It is preferable that the dielectric 81 has a high glass transition point and a high dielectric voltage as well as a low dielectric constant, and is formed of a material having a low dielectric dissipation factor. A metal oxide is preferable and ZrO₂ is especially preferable as a material for forming the dielectric 81. The thickness of the dielectric 81 is adjusted depending on the distance between the first electrode 32-1 and the second electrode 32-2, the dielectric voltage of the dielectric 81, a voltage, and the like. In order to enable the first electrode 32-1 to be protected without causing hindrance to generation of discharge light, the thickness is adjusted to a thickness in which dielectric breakdown does not occur in the dielectric 81 even if a voltage is applied to the dielectric 81.

In the present embodiment, an amino group-containing compound, particularly nitrosamine or nitramine, accompanied by a CO₂-removed exhaust gas 28 can be efficiently removed to very low concentration, and the amino group-containing compound can be inhibited from being accompanied by the CO₂-removed exhaust gas 28 and from being released from within an absorption tower 11 into atmosphere. Because discharge light is commonly influenced by gas composition of O₂, N₂, CO₂, and the like contained in the CO₂-removed exhaust gas 28, a humidity in the CO₂-removed exhaust gas 28, and the like, purification of the amino group-containing compound accompanied by the CO₂-removed exhaust gas 28 may fail to satisfy predetermined performance, thereby precluding stable removal of the CO₂-removed exhaust gas 28, depending on the conditions of the CO₂-removed exhaust gas 28. For example, when the gas composition of an exhaust gas 21 supplied to the absorption tower 11 deviates from a predetermined range demanded for stably purifying the exhaust gas during, e.g., starting a thermal power plant, a CO₂ capture and storage (CCS) apparatus, or the like, a discharge state becomes unstable, and therefore, electric discharge concentrates locally on a portion between the first electrode 32-1 and the second electrode 32-2, whereby a so-called spark can be generated, resulting in damage to the catalytic unit 31. For example, when the amounts of oxygen, CO₂, moisture, and the like become large with respect to the amount of nitrogen in the exhaust gas 21, resulting in the increased gas composition of oxygen, CO₂, moisture, and the like in the exhaust gas 21, ions such as CO₂⁻, O₂⁻, O⁻, and OH⁻ are generated, resulting in a decrease in current, whereby a voltage tends to increase. As a result, the discharge state changes and becomes unstable. When the humidity of the exhaust gas 21 is high, electric discharge concentrates locally on the portion between the first electrode 32-1 and the second electrode 32-2, whereby a spark can be generated, resulting in damage to the catalytic unit 31. The spark generated in this case is considered to be generated due to release of accumulated charge with a rush through the medium of moisture.

In the present embodiment, the dielectric 81 is disposed on the surface, facing the catalytic unit 31, of the second electrode 32-2, and therefore, electric discharge can be inhibited from concentrating and being generated locally on the portion between the first electrode 32-1 and the second electrode 32-2, resulting in generation of stable discharge light, even if the conditions of the CO₂-removed exhaust gas 28, such as the gas composition and humidity of the CO₂-removed exhaust gas 28, change.

The measurement unit 82 measures the current value of the first electrode 32-1 or the second electrode 32-2. It is essential only that the measurement unit 82 can measure the current of the first electrode 32-1 or the second electrode 32-2. A known ammeter or the like can be used as the measurement unit 82. When electric discharge concentrates locally on the portion between the first electrode 32-1 and the second electrode 32-2, resulting in generation of a spark, a high current passes through the first electrode 32-1 or the second electrode 32-2. Therefore, the presence or absence of generation of a spark between the first electrode 32-1 and the second electrode 32-2 can be detected by measuring the current value of the first electrode 32-1 or the second electrode 32-2. A measurement result from the measurement unit 82 is transmitted to the controlling unit 83.

The controlling unit 83 adjusts a current supplied to the first electrode 32-1 or the second electrode 32-2 based on the measurement result from the measurement unit 82, to adjust a voltage applied to the electrode. In the present embodiment, the controlling unit 83 determines that a spark is generated between the first electrode 32-1 and the second electrode 32-2 in the case of detecting that the current value of the first electrode 32-1 or the second electrode 32-2 is increased based on the measurement result from the measurement unit 82. In this case, the controlling unit 83 adjusts a current supplied from a power supply unit 33 to perform adjustment of a voltage applied to the first electrode 32-1 and the second electrode 32-2, such as, for example, reduction in voltage applied to the first electrode 32-1 and the second electrode 32-2, or cutting of the voltage to zero. As a result, when a spark is generated between the first electrode 32-1 and the second electrode 32-2, the influence of the spark on the first electrode 32-1 and the second electrode 32-2 can be reduced. Further, damage to the dielectric 81 due to the spark and spreading of the damage over the first electrode 32-1 and the second electrode 32-2 can be suppressed.

Thus, according to the present embodiment, the CO₂ recovery apparatus 10G can stably purify the CO₂-removed exhaust gas 28 because the disposition of the dielectric 81 on the surface, facing the catalytic unit 31, of the second electrode 32-2 enables a spark generated by local concentration of electric discharge on the portion between the first electrode 32-1 and the second electrode 32-2 to be inhibited from damaging the catalytic unit 31.

In the present embodiment, the CO₂ recovery apparatus 10G enables damage to the catalytic unit 31 due to a spark generated between the first electrode 32-1 and the second electrode 32-2 to be further reduced based on the measurement result from the measurement unit 82 and can therefore inhibit the performance of purifying the CO₂-removed exhaust gas 28 from deteriorating.

Not that, in the present embodiment, the dielectric 81 is disposed on the whole surface, facing the catalytic unit 31, of the second electrode 32-2. However, the dielectric 81 may be disposed only on a part of the second electrode 32-2. The dielectric 81 is disposed on the surface, facing the catalytic unit 31, of the second electrode 32-2, but the dielectric 81 may be disposed on a surface, facing the catalytic unit 31, of the first electrode 32-1, or may be disposed on at least a part of each surface, facing the catalytic unit 31, of the pair of first electrode 32-1 and second electrode 32-2.

The present embodiment comprises the dielectric 81, the measurement unit 82, and the controlling unit 83. However, without limitation thereto, only the dielectric 81 may be disposed, or only the measurement unit 82 and the controlling unit 83 may be disposed.

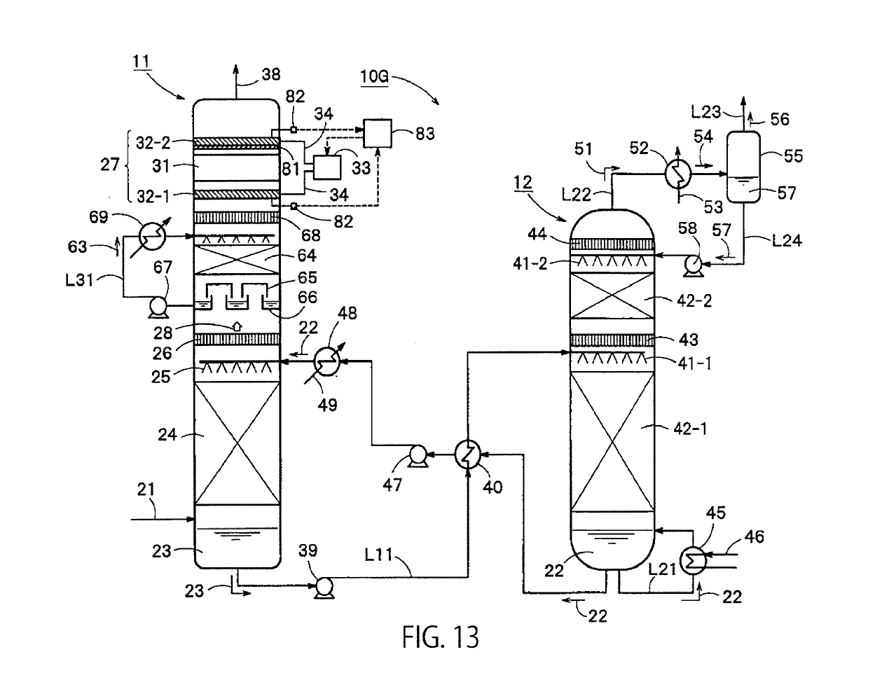

Further, the present embodiment can be used in combination with each of the above-described embodiments, as appropriate. For example, as illustrated in FIG. 13, the CO₂ recovery apparatus 10G may comprise: the water cleaning unit disposed between the CO₂ absorption unit 24 and the purification unit 27; and a cooler 69 that is disposed in a cleaning water circulation line L31 and cools in advance cleaning water 63 supplied to the water cleaning unit 64. The cleaning water 63 supplied from the top side of the water cleaning unit 64 is brought into gas-liquid contact with the CO₂-removed exhaust gas 28 moving upward toward the water cleaning unit 64 through a tray 65 in the water cleaning unit 64, to recover an amino group-containing compound accompanied by the CO₂-removed exhaust gas 28 in the cleaning water 63. The cleaning water 63 stored in a liquid storage unit 66 in the tray 65 is passed through the cleaning water circulation line L31 by a pump 67, is cooled in advance to, for example, 5 to 30° C. by the cooler 69, and is then circulated to the water cleaning unit 64 to bring the cleaning water 63 into gas-liquid contact with the CO₂-removed exhaust gas 28 in the water cleaning unit 64. Commonly, it is easy to generate a spark between the first electrode 32-1 and the second electrode 32-2 when the CO₂-removed exhaust gas 28 has a high humidity in the purification unit 27. In the present embodiment, the cooled cleaning water 63 is supplied to the water cleaning unit 64, and therefore, the CO₂-removed exhaust gas 28 is cooled. By decreasing the gas temperature of the CO₂-removed exhaust gas 28, the saturated vapor pressure (saturated humidity) of the CO₂-removed exhaust gas 28 is decreased to decrease the water content of the CO₂-removed exhaust gas 28. The lower the saturated humidity of the CO₂-removed exhaust gas 28 is, the lower the humidity of the CO₂-removed exhaust gas 28 can be allowed to be. Therefore, a spark can be inhibited from being generated between the first electrode 32-1 and the second electrode 32-2. The lower the saturated humidity of the CO₂-removed exhaust gas 28 is, the more easily the discharge light can be generated in the purification unit 27. Therefore, a discharge effect in the purification unit 27 can be highly maintained. As a result, the efficiency of purifying the CO₂-removed exhaust gas 28 in the purification unit 27 can be raised, and therefore, the size of the purification unit 27 can be reduced.

### Eighth Embodiment

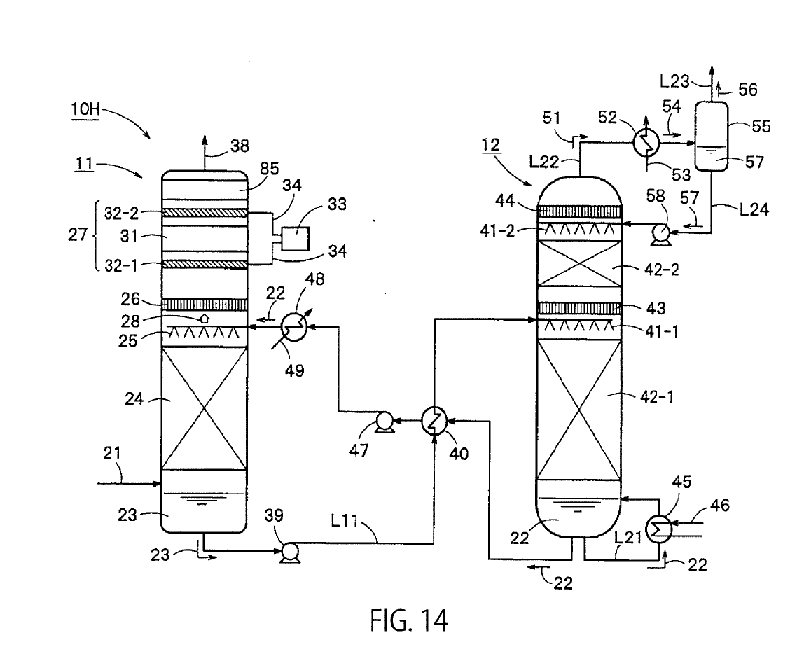

A CO₂ recovery apparatus according to an eighth embodiment will be described with reference to the drawings. Note that the same sign will be applied to a member having the same function as that in the embodiment described above, and the detailed description thereof will be omitted. FIG. 14 is a schematic view illustrating the construction of the CO₂ recovery apparatus according to the eighth embodiment. As illustrated in FIG. 14, the CO₂ recovery apparatus 10H comprises a product removal unit 85 in an absorption tower 11. The product removal unit 85 is disposed on a downstream side of the purification unit 27 in the flow direction of the CO₂-removed exhaust gas 28 and is disposed in the upper side in the absorption tower 11.

The product removal unit 85 removes a decomposition product generated when an amino group-containing compound is decomposed in a purified gas 38. The decomposition product is a product generated when the amino group-containing compound is partly decomposed and removed in a catalytic unit in the purification unit 27. For example, acetaldehyde, formic acid, or the like is produced from the amino group-containing compound and is contained as the decomposition product in the purified gas 38.

The product removal unit 85 is formed of a solid adsorbent that adsorbs the decomposition product on a carrier surface to remove the decomposition product from the purified gas 38. For example, a porous body such as active carbon can be used as the solid adsorbent. The product removal unit 85 may have a construction similar to the construction of the water cleaning unit 64, as well as the solid adsorbent, and may bring the decomposition product in the purified gas 38 into gas-liquid contact with a cleaning liquid such as water to allow the decomposition product to be absorbed in the cleaning liquid. The product removal unit 85 in which the decomposition product is adsorbed may be taken outside the absorption tower 11, and the decomposition product may be recovered and utilized from the product removal unit 85.

Thus, according to the present embodiment, the CO₂ recovery apparatus 10H is capable of removing a decomposition product generated due to decomposition of an amino group-containing compound when the CO₂-removed exhaust gas 28 is purified, and therefore can further stably inhibit a product generated due to the amino group-containing compound from being released into atmosphere.

In each of the embodiments described above, a case in which the exhaust gas 21 contains CO₂ as an acid gas is described. However, the present embodiments can also be similarly applied to a case in which another acid gas such as H₂S, COS, CS₂, NH₃, or HCN, other than CO₂, is contained. In addition, the present embodiments can also be similarly applied to a case in which the exhaust gas 21 does not contain CO₂ but contains the other acid gases described above. Therefore, the present embodiments can also be similarly applied to a case in which acid gas components contained in, for example, gases such as gasified gas produced by gasifying fuels such as coal in gasification furnaces, coal gasified gas, synthesis gas, coke oven gas, petroleum gas, and natural gas, as well as combustion exhaust gases discharged from boilers, gas turbines, and the like in thermal power plants and the like, and process exhaust gases generated in ironworks, as the exhaust gases 21, are removed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### EXAMPLES

The present invention will be further specifically described below with reference to Examples and Comparative Examples. However, the present invention is not limited to the following Examples.

### Example 1

### [Production of Photocatalytic Module]

### (Carrier)

A silicate containing cordierite (Mg₂Al₄Si₅O₁₈) as a principal component and having a three-dimensional mesh structure with an open porosity of 75% was used for a carrier.

### (Preparation of Mixture for Forming Photocatalytic Unit)

To titanium oxide sol having a concentration of 30 mass % and a crystal particle diameter of 6 nm, 5 parts by mass of zeolite having a pore diameter of 6 Å with respect to 100 parts by mass of titanium oxide in the titanium oxide sol was added, and polyethylene glycol (Polyethylene Glycol 200, manufactured by Wako Pure Chemical Industries, Ltd.) was added at a weight ratio of 10:3 between the titanium oxide sol and the polyethylene glycol, whereby a mixture for forming a photocatalytic unit was prepared.

(Production of Structure having Photocatalytic Unit)

A carrier was coated and impregnated with the mixture for forming a photocatalytic unit, dried, and then heat-treated in atmosphere at 600° C. for 4 hours. As a result, a structure (photocatalytic structure) in which a photocatalytic unit was formed on the carrier was obtained. The photocatalytic structure had a three-dimensional mesh structure corresponding to the shape of the carrier and was formed so that air was able to pass through the structure. The size of the photocatalytic structure was length of 70 mm×breadth of 30 mm×air-passing-direction thickness of 6 mm.

### (Electrode)

Two electrodes that were made of stainless steel and had a honeycomb structure were used. The size of the electrode was around length of 70 mm×breadth of 30 mm×air-passing-direction thickness of 3 mm.

### (Production of Photocatalytic Module)

The photocatalytic structure and the two electrodes were arranged in the order of the first electrode, the photocatalyst structure, and the second electrode in a cylindrical housing having a rectangular cross-sectional shape (length of 80 mm×breadth of 40 mm×air-passing-direction thickness of 25 mm). A direct-current power source was connected to a portion between the first electrode and the second electrode so that a voltage was able to be applied to the portion, whereby a photocatalytic module was produced. The size of the photocatalytic module was set at 8×4×2.5 cm.

### [Evaluation]

The decomposition performances of nitrosamine and nitramine were measured by a method described below using the obtained photocatalytic module. The measurement results are shown in Table 1.

### (Decomposition Performance of Nitrosamine)

A gas having a humidity of 30% and a nitrosamine concentration of 500 ppb was allowed to flow at 10 L/min into the cylindrical housing. In this state, a voltage of 6 kV was applied using the direct-current power source so that the first electrode was a positive electrode and the second electrode was a negative electrode, and the concentration (ppb) of nitrosamine in a gas discharged from the cylindrical housing was measured.

### (Decomposition Performance of Nitramine)

A gas having a humidity of 30% and a nitramine concentration of 500 ppb was allowed to flow at 10 L/min into the cylindrical housing. In this state, a voltage of 6 kV was applied using the direct-current power source so that the first electrode was a positive electrode and the second electrode was a negative electrode, and the concentration (ppb) of nitramine in a gas discharged from the cylindrical housing was measured.

### Example 2

### [Production of Purification Unit 1]

### (Production of Ozone Decomposition Filter)

An ozone decomposition filter having a honeycomb structure obtained by baking manganese oxide was produced.

### (Production of Purification Unit 1)

The photocatalytic structure, the two electrodes, and the ozone decomposition filter were arranged in the order of the first electrode, the photocatalytic structure, the second electrode, and the ozone decomposition filter in a cylindrical housing having a rectangular cross-sectional shape. A direct-current power source was connected the first electrode and the second electrode so that a voltage was able to be applied between the first electrode and the second electrode, whereby a purification unit 1 was produced.

### [Evaluation]

The decomposition performance of each of nitrosamine and nitramine was measured by a method similar to that in the above-described Example 1 using the obtained purification unit 1. The measurement results are shown in Table 1.

### Example 3

### [Production of Purification Unit 2]

A fill layer (water cleaning unit) to which water (30 to 35° C.) was supplied, the photocatalytic structure, and the two electrodes were arranged in the order of the water cleaning unit, the first electrode, the photocatalytic structure, and the second electrode in a cylindrical housing having a rectangular cross-sectional shape. The height of the water cleaning unit was set at about 30 cm. A direct-current power source was connected to a portion between the first electrode and the second electrode so that a voltage was able to be applied to the portion, whereby a purification unit 2 was produced.

### [Evaluation]

The decomposition performance of each of nitrosamine and nitramine was measured by a method similar to that in the above-described Example 1 using the obtained purification unit 2. The measurement results are shown in Table 1.

### Example 4

### [Production of Purification Unit 3]

A fill layer to which cooling water (about 20° C.) was supplied, the photocatalyst structure, and the two electrodes were arranged in the order of the fill layer to which the cooling water was supplied, the first electrode, the photocatalyst structure, and the second electrode in a cylindrical housing having a rectangular cross-sectional shape. The height of the fill layer was set at about 30 cm. A direct-current power source was connected the first electrode and the second electrode so that a voltage was able to be applied between the first electrode and the second electrode, whereby a purification unit 3 was produced.

### [Evaluation]

The decomposition performance of each of nitrosamine and nitramine was measured by a method similar to that in the above-described Example 1 using the obtained purification unit 3. The measurement results are shown in Table 1.

### Example 5

### [Production of Purification Unit 4]

A fill layer (acid cleaning unit) to which a sulfuric acid solution was supplied, the photocatalytic structure, and the two electrodes were arranged in the order of the fill layer (acid cleaning unit) to which a sulfuric acid solution was supplied, the first electrode, the photocatalyst structure, and the second electrode in a cylindrical housing having a rectangular cross-sectional shape. The height of the acid cleaning unit was set at about 30 cm. A direct-current power source was connected to between the first electrode and the second electrode so that a voltage was able to be applied to between the first electrode and the second electrode, whereby a purification unit 4 was produced.

### [Evaluation]

The decomposition performance of each of nitrosamine and nitramine was measured by a method similar to that in the above-described Example 1 using the obtained purification unit 4. The measurement results are shown in Table 1.

### Comparative Example 1

Only a fill layer to which water was supplied was arranged in a cylindrical housing having a rectangular cross-sectional shape. Then, the decomposition performance of each of nitrosamine and nitramine was measured by a method similar to that in the above-described Example 1. The measurement results are shown in Table 1.

### Comparative Example 2

Only a fill layer to which a sulfuric acid solution was supplied was arranged in a cylindrical housing having a rectangular cross-sectional shape. Then, the decomposition performance of each of nitrosamine and nitramine was measured by a method similar to that in the above-described Example 1. The measurement results are shown in Table 1.

### Comparative Example 3

Only active carbon was arranged in a cylindrical housing having a rectangular cross-sectional shape. Then, the decomposition performance of nitrosamine was measured by a method similar to that in the above-described Example 1. The measurement results are shown in Table 1.

TABLE 1

| | Nitrosamine | | | Nitramine | | |
|---|---|---|---|---|---|---|
| | | | Decomposition | | | Decomposition |
| | Concentration (ppb) | | rate | Concentration (ppb) | | rate |
| | Inlet side | Outlet side | (%) | Inlet side | Outlet side | (%) |
| Example 1 | 500 | ≦2 | ≧99.6 | 500 | ≦2 | ≧99.6 |
| Example 2 | 500 | ≦1 | ≧99.8 | 500 | ≦1 | ≧99.8 |
| Example 3 | 500 | ≦2 | ≧99.6 | 500 | ≦2 | ≧99.6 |
| Example 4 | 500 | ≦1 | ≧99.8 | 500 | ≦1 | ≧99.8 |
| Example 5 | 500 | ≦2 | ≧99.6 | 500 | ≦2 | ≧99.6 |
| Comparative | 500 | 380 | 24 | 500 | 380 | 24 |
| Example 1 | | | | | | |
| Comparative | 500 | 90 | 82 | 500 | 80 | 84 |
| Example 2 | | | | | | |
| Comparative | 500 | 70 | 86 | — | — | — |
| Example 3 | | | | | | |

Based on the results shown in Table 1, it was confirmed that the efficiency of decomposing nitrosamine and nitramine particularly became high in comparison with the other purification methods by using the photocatalyst module. Further, it was confirmed that the efficiency of decomposing nitrosamine and nitramine further became higher by using a purification unit comprising an ozone decomposition apparatus or the like in the photocatalyst module.

1. A carbon dioxide recovery apparatus comprising:
an absorption tower comprising a CO₂ absorption unit in which an exhaust gas containing CO₂ and an absorbing liquid comprising an amino group-containing compound are brought into gas-liquid contact with each other to allow the absorbing liquid to absorb the CO₂;
a regeneration tower in which the CO₂ contained in the absorbing liquid which absorbed the CO₂ is separated to regenerate the absorbing liquid; and
a purification unit in which an amino group-containing compound in a CO₂-removed exhaust gas obtained by removing the CO₂ in the CO₂ absorption unit is removed from,
wherein the purification unit comprises:
a catalytic unit in which a photocatalyst is supported on a carrier comprising a gap through which air can pass; and
an activation member which activates the photocatalyst.

2. The carbon dioxide recovery apparatus according to claim 1, wherein the activation member comprises either or both of an ultraviolet light lamp and a pair of electrode which comprises a first electrode and a second electrode that is disposed to be opposed to the first electrode, the first electrode and the second electrode being electrodes in a pair.

3. The carbon dioxide recovery apparatus according to claim 1, wherein the catalytic unit has an open porosity of 60 to 90%.

4. The carbon dioxide recovery apparatus according to claim 1, further comprising an ozone decomposition unit provided on a downstream side of the purification unit in a flow direction of the CO₂-removed exhaust gas,
wherein the ozone decomposition unit decomposes ozone in a purified CO₂-removed exhaust gas.

5. The carbon dioxide recovery apparatus according to claim 1, further comprising a water cleaning unit provided between the CO₂ absorption unit and the purification unit,
wherein the water cleaning unit brings the CO₂-removed exhaust gas into contact with cleaning water to remove an amino group-containing compound from the CO₂-removed exhaust gas.

6. The carbon dioxide recovery apparatus according to claim 5, further comprising a cooling unit that cools the cleaning water supplied to the water cleaning unit.

7. The carbon dioxide recovery apparatus according to claim 1, further comprising an acid cleaning unit provided on an upstream side of the purification unit in a flow direction of the CO₂-removed exhaust gas,
wherein the acid cleaning unit brings the CO₂-removed exhaust gas into contact with an acid solution to remove an amino group-containing compound from the CO₂-removed exhaust gas.

8. The carbon dioxide recovery apparatus according to claim 1,
wherein the activation member is a pair of electrodes comprising a first electrode and a second electrode; and
wherein the carbon dioxide recovery apparatus further comprises a dielectric on at least a part of an opposed face, facing the catalytic unit, of either or both of the pair of the electrodes.

9. The carbon dioxide recovery apparatus according to claim 1,
wherein the activation member is a pair of electrodes comprising a first electrode and a second electrode; and
wherein the carbon dioxide recovery apparatus further comprises a product removal unit provided on a downstream side of the purification unit in a flow direction of the CO₂-removed exhaust gas,
where the product removal unit removes a decomposition product generated by decomposing the amino group-containing compound in a purified CO₂-removed exhaust gas.

10. The carbon dioxide recovery apparatus according to claim 1,
wherein the activation member is a pair of electrodes comprising a first electrode and a second electrode; and
wherein the carbon dioxide recovery apparatus further comprises:
a measurement unit that measures a current value of the first electrode or the second electrode; and
a controlling unit that adjusts a current supplied to the first electrode and the second electrode based on a detection result from the measurement unit.

11. A method for treating an exhaust gas, comprising:
a CO₂ recovery step of bringing an exhaust gas containing CO₂ and an absorbing liquid comprising an amino group-containing compound into gas-liquid contact with each other in a CO₂ absorption unit in an absorption tower to allow the absorbing liquid to absorb the CO₂; and
a purification step of activating a catalytic unit in which a photocatalyst is supported on a carrier comprising a gap through which air can pass while supplying a CO₂-removed exhaust gas obtained by removing the CO₂ in the CO₂ absorption unit to the catalytic unit, to decompose and remove an amino group-containing compound contained in the CO₂-removed exhaust gas.

12. The method for treating an exhaust gas according to claim 11, wherein, in the purification step, a voltage is applied to a first electrode and a second electrode arranged on both sides of the catalytic unit to generate a discharge light between the first electrode and the second electrode and to decompose and remove an amino group-containing compound contained in the CO₂-removed exhaust gas.

13. The method for treating an exhaust gas according to claim 12,
wherein a current of a first electrode and a second electrode arranged so as to pinch the catalytic unit are measured;
a current supplied to the first electrode and the second electrode is adjusted based on a measured current value; and
a current is inhibited from concentrating on a portion between the first electrode and the second electrode, resulting in generation of a spark.

14. The method for treating an exhaust gas according to claim 11, further comprising a regeneration step of supplying the absorbing liquid allowed to absorb the CO₂ in the absorption tower to a regeneration tower, releasing the CO₂ from the absorbing liquid allowed to absorb the CO₂, and regenerating the absorbing liquid.

15. The method for treating an exhaust gas according to claim 11, wherein the CO₂-removed exhaust gas comprises either or both of nitrosamine and nitramine.
